(19) United States
(12) Patent Application Publication
(10) Pub. No.: US 2019/0359384 A1
(43) Pub. Date: Nov. 28, 2019

(54) Containers for Storage and Assembly of Sandwiches

(71) Applicants: Dane C Reiley, Los Angeles, CA (US); Christopher Lee Smith-Adkins, Brooklyn, NY (US)

(72) Inventors: Dane C Reiley, Los Angeles, CA (US); Christopher Lee Smith-Adkins, Brooklyn, NY (US)

(21) Appl. No.: 15/980,626

(22) Filed: May 15, 2018

(51) Int. Cl. B65D 25/08; B65D 43/16

(52) U.S. Cl. CPC B65D 25/08; A47J 47/08; B65D 43/163

(57) ABSTRACT

Containers for storage and assembly of sandwiches in accordance with embodiments of the invention are disclosed. In one embodiment, a container for storage and assembly of a sandwich is provided, the container comprising: a first compartment for receiving a first piece of bread; a second compartment for receiving a second piece of bread; and a middle compartment comprising a first flap, a second flap, and a connecting member that connects the flaps. The flaps of the middle compartment may be used to separate the three compartments and any food items therein.

### FIELD OF THE INVENTION

The present invention generally relates to containers, and more specifically to containers for storage and assembly of sandwiches.

### BACKGROUND

Sandwiches are a popular type of food for many reasons including transportability. For example, sandwiches may be taken to work, school, or picnics to be eaten as part of a packed lunch. Generally, sandwiches may be any dish wherein two or more pieces of bread serve as a container or wrapper for another food type (e.g., fill ingredients). Although various types of sandwiches may be consumed, a sandwich may include various fill ingredients, such as but not limited to, vegetables, sliced cheese, and/or meat, that may be placed on or between one or more pieces of bread.

### SUMMARY OF THE INVENTION

The various embodiments of the present invention contain several features, no single one of which is solely responsible for their desirable attributes. Without limiting the scope of the present embodiments, their more prominent features will now be discussed below. In particular, the present invention will be discussed in the context of storage and assembly of sandwiches. However, the use of the invention as a container for storage and assembly of sandwiches is merely exemplary and various other containers may be utilized for storage and assembly of other food products as appropriate to the requirements of a specific application in accordance with various embodiments of the invention. After considering this discussion, and particularly after reading the section entitled “Detailed Description,” one will understand how the features of the present embodiments provide the advantages described here.

One aspect of the present embodiments includes the realization that in current container devices other than the present embodiments, if a sandwich is prepared some time before consumption, the bread of the sandwich tends to become soggy due to exposure to the ingredients (may also be referred to as “fill ingredients”) between the pieces of bread. For example, the ingredients between the pieces of bread may transfer their moisture to the pieces of bread, thereby causing the pieces of bread to become soggy and lose structural integrity.

In a first aspect, a container for storage and assembly of a sandwich is provided, the container comprising: a first compartment for receiving a first piece of bread, the first compartment comprising opposing side walls, a back wall having a first opening, an outside wall, a first open portion opposite the back wall, and a second open portion opposite the outside wall; a second compartment for receiving a second piece of bread, comprising opposing side walls, a back wall having a second opening, an outside wall, a first open portion opposite the back wall, and a second open portion being opposite the outside wall, wherein the first compartment back wall is connected to the second compartment back wall at a first hinge allowing for the container to be positioned between an open configuration and a closed configuration; and a middle compartment comprising a first flap, a second flap connected to a connecting member, and a second hinge, wherein the connecting member connects with the first flap at the second hinge allowing for the first flap to rotate about the second hinge when the container is positioned between the open configuration and the closed configuration.

In an embodiment of the first aspect, the opposing side walls of the first storage container have first slotted tracks, and the first flap is configured to be placed through the first opening and guided into the first slotted tracks of the opposing side walls of the first compartment.

In another embodiment of the first aspect, the opposing side walls of the second compartment have second slotted tracks, and the second flap is configured to be placed through the second opening and guided into the second slotted tracks of the opposing side walls of the second compartment.

In another embodiment of the first aspect, the container for storage and assembly of a sandwich further comprises a lid having a closing fastener, the lid may hingedly connect to the second compartment, which allows for the lid to be positioned between an unlocked position and a locked position, and the closing fastener may be configured to attach to the first compartment to secure the container when the lid is in the locked position.

In another embodiment of the first aspect, the first slotted tracks and the second slotted tracks may have latches indicating an inserted middle compartment position and a removed middle compartment position, and the first flap and the second flap have end points that lock into the latches and allow for the middle compartment to be positioned between the inserted position and removed position.

In another embodiment of the first aspect, the end points may provide an audible sound when the middle compartment is positioned into the inserted position and the removed position.

In another embodiment of the first aspect, the back wall of the second compartment may have a grease trap to prevent fill ingredients from escaping from the middle compartment.

In another embodiment of the first aspect, the connecting member may have a tab to grasp when positioning the middle compartment into the inserted position and/or removed position.

In another embodiment of the first aspect, a first set of grooves may be disposed in the opposing side walls of the first compartment, and a second set of grooves may be disposed in the opposing side walls of the second compartment. The first set of grooves and the second set of grooves may be configured to interlock with each other when the container is positioned into the closed configuration.

In a second aspect, a method for storing and assembling a sandwich is provided, the method comprising the steps of: positioning a middle compartment of a container into an inserted position, the middle compartment comprising: a first flap, a second flap connected to a connecting member, and a second hinge, wherein the connecting member connects with the first flap at the second hinge allowing for the first flap to rotate about the second hinge when the container is positioned between an open configuration and a closed configuration; placing a first piece of bread into a first compartment, the first compartment comprising: opposing side walls, a back wall having a first opening, an outside wall, a first open portion opposite the back wall, and a second open portion opposite the outside wall; placing a second piece of bread into a second compartment, the second compartment comprising: opposing side walls, a back wall having a second opening, an outside wall, a first open portion opposite the back wall, and a second open portion being opposite the outside wall; positioning the container into an open configuration; placing sandwich fill ingredients into the middle compartment; and positioning the container into a closed configuration.

In an embodiment of the second aspect, the positioning the middle compartment into the inserted position step comprises the step of: grasping a tab located on the connecting member of the middle compartment and causing the first flap to move between first slotted tracks disposed in the opposing side walls of the first compartment and the second flap to move between second slotted tracks disposed in the opposing side walls of the second compartment such that the middle compartment is positioned into the inserted position.

In an embodiment of the second aspect, the placing the first piece of bread in the first compartment step comprises the step of: placing the first piece of bread through the first open portion of the first compartment and into the first compartment.

In an embodiment of the second aspect, the placing the second piece of bread in the second compartment step comprises the step of: placing the second piece of bread through the first open portion of the second compartment and into the second compartment.

In another embodiment of the second aspect, the positioning the container into an open configuration step comprises the step of: rotating the first compartment about a first hinge such that the container is positioned into the open configuration, wherein the first hinge connects the first compartment to the second compartment.

In another embodiment of the second aspect, the positioning the container into a closed configuration step comprises the step of: rotating the first compartment about the first hinge such that the container is positioned into the closed configuration.

In another embodiment of the second aspect, the method further comprises positioning a lid of the container into a locked position, the lid having a closing fastener and being connected to the container

In another embodiment of the second aspect, the positioning the lid into the locked position comprises the steps of: positioning the lid such that a side of the lid covers the first open portion of the first compartment, the middle compartment, and the first open portion of the second compartment; and attaching the closing fastener to the first compartment to secure the container when the lid is in the locked position.

In another embodiment of the second aspect, the method of storing and assembling a sandwich further comprises positioning the lid into an unlocked position; and positioning the middle compartment of the container into a removed position.

In another embodiment of the second aspect, the positioning the lid into the unlocked position step comprises the steps of: detaching the closing fastener from the first compartment; and positioning the lid such that the side of the lid no longer covers the first open portion of the first compartment, the middle compartment, and the first open portion of the second compartment.

In another embodiment of the second aspect, the positioning the middle compartment into the removed position step comprises the step of: grasping a tab located on the connecting member of the middle compartment and causing the first flap to move between first slotted tracks disposed in the opposing side walls of the first compartment and the second flap to move between second slotted tracks disposed in the opposing side walls of the second compartment such that the middle compartment is positioned into the removed position.

### BRIEF DESCRIPTION OF THE DRAWINGS

The various embodiments of the present container for storage and assembly of a sandwich now will be discussed in detail with an emphasis on highlighting the advantageous features. These embodiments depict the novel and non-obvious containers for storage and assembly of sandwiches shown in the accompanying drawings, which are for illustrative purposes only. These drawings include the following figures:

FIG. 1 is a front prospective view of a sandwich container showing the lid in an unlocked position and the container in an open configuration in accordance with an embodiment of the invention;

FIG. 2 is a left side cross-sectional view of the sandwich container in accordance with an embodiment of invention;

FIG. 3A is a left side cross-sectional view of a sandwich container with the container in a closed configuration and the lid in a locked position in accordance with an embodiment of the invention;

FIG. 3B is a left side view of a sandwich container showing the middle compartment inserted in accordance with an embodiment of the invention;

FIG. 3C is a front view of a sandwich container with the lid in a locked position and the container in a closed configuration in accordance with an embodiment of the invention;

FIG. 3D is a rear view of a sandwich container in accordance with an embodiment of the invention;

FIG. 3E is a top view of a sandwich container with the middle compartment inserted in accordance with an embodiment of the invention;

FIG. 4 is a left side cross-sectional view of a sandwich container with the middle compartment removed and the container in a closed configuration in accordance with an embodiment of the invention;

FIG. 5 is a left side cross-sectional view of a sandwich container with the middle compartment removed and the container in an open configuration in accordance with an embodiment of the invention;

FIG. 6 is a rear cross-sectional view of a sandwich container with the container in a closed configuration in accordance with an embodiment of the invention;

FIG. 7 is a flow chart illustrating a process for storing a sandwich in accordance with an embodiment of the invention;

FIG. 8 is a flow chart illustrating a process for storing and assembling a sandwich in accordance with an embodiment of the invention;

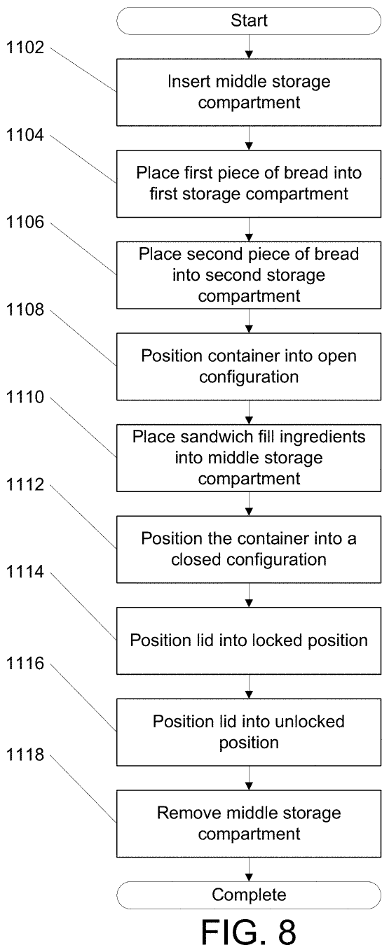

FIG. 9 is a left side prospective view of a sandwich container showing the middle compartment inserted and the container in a closed configuration with the lid unlocked in accordance with an embodiment of the invention;

FIG. 10 is a front prospective view of a sandwich container showing the lid in an unlocked position and the container in an open configuration with fill ingredients inserted into the middle compartment in accordance with an embodiment of the invention;

FIG. 11 is a left side prospective view of a sandwich container showing the middle compartment inserted and the container in a closed configuration with the lid in a locked position in accordance with an embodiment of the invention;

FIG. 12 is a left side prospective view of a sandwich container showing the middle compartment removed and the container in a closed configuration with the lid in a locked position in accordance with an embodiment of the invention; and

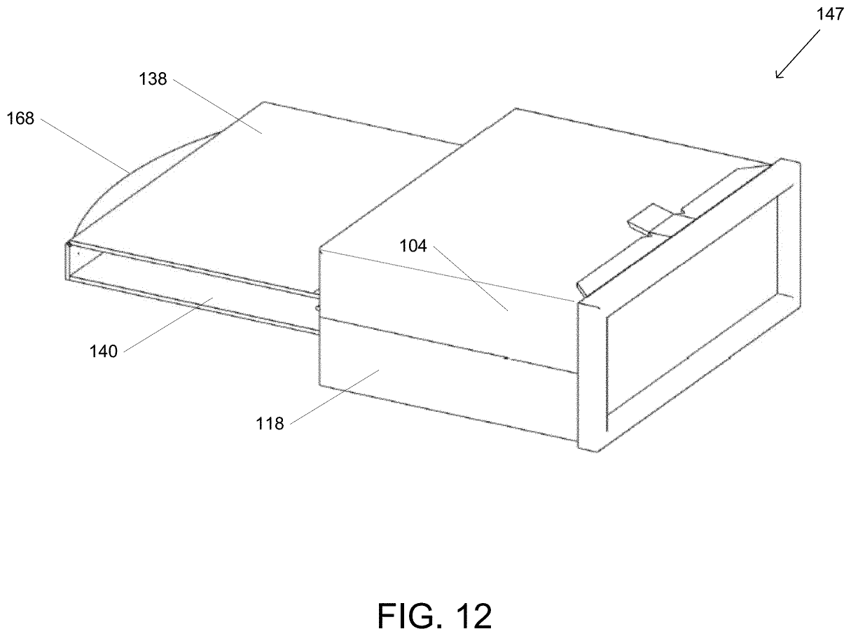

FIG. 13 is a left side prospective view of a sandwich container showing the middle compartment removed and the container in an open configuration with the lid in an unlocked position in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, devices and methods for storage and assembly of sandwiches in accordance with embodiments of the invention are disclosed. In many embodiments, a storage container may include three or more compartments separated by adjustable flaps that may act as barriers between pieces of bread and various fill ingredients, as further described below. In various embodiments, the separation of the pieces of bread and fill ingredient may prevent the bread from becoming soggy during storage. In several embodiments, the adjustable flaps of the middle compartment may be removed as barriers such that the pieces of bread of the sandwich and the fill ingredient are brought together, thereby assembling the sandwich. A container for storing and assembling a sandwich in accordance with embodiments of the invention are further discussed below.

### Containers for Storage and Assembly of Sandwiches

In various embodiments of the present invention, a container for storing and assembling a sandwich may comprise at least three compartments for separating sandwich ingredients. Further separation of sandwich ingredients may involve additional compartments. In many embodiments, the container may be formed from plastic or any other suitable material or combination thereof, known to one of ordinary skill in the art, to allow for a dishwasher-safe and/or microwavable container.

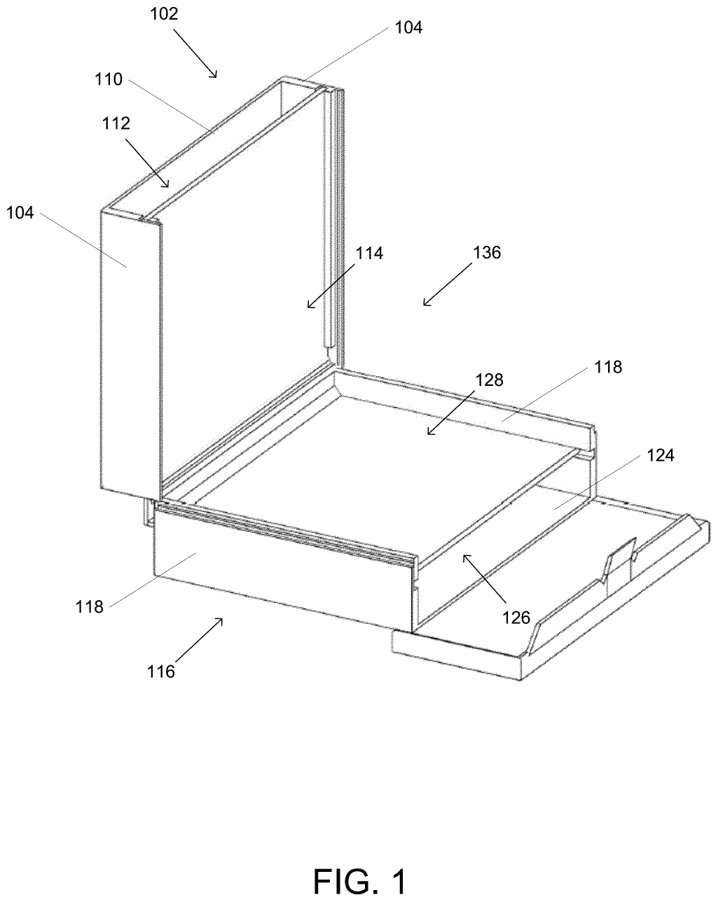

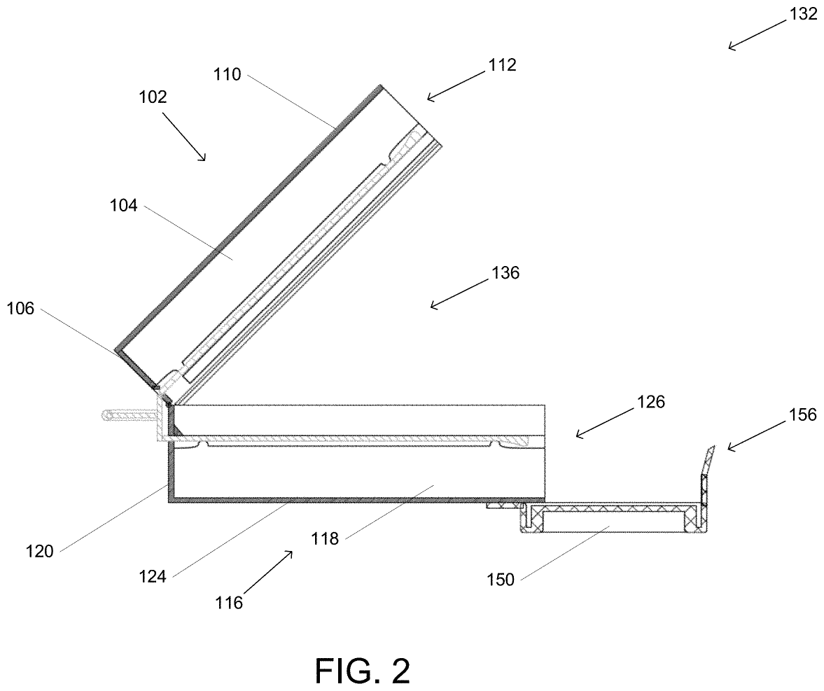

Turning to FIGS. 1 and 2, a container in accordance with an embodiment of the present invention is shown. In the embodiment shown, the container may comprise a first compartment 102, a second compartment 116, and a middle compartment 136, that may be configured in an open configuration, as further described below. In many embodiments, the first and second compartments may be hingedly connected and the middle compartment may be removable, as further described below. In various embodiments, one or more pieces of bread may be placed in the first compartment 102 and second compartment 116 while sandwich fill ingredients may be placed in the middle compartment 136. For example, a first compartment 102, in accordance with an embodiment of the invention, may be a substantially rectangular box with opposing side walls 104, a back wall 106, a first open portion 112 situated opposite the back wall 106, an outside wall 110, and a second open portion 114 situated opposite the outside wall 110 and configured to receive a first flap of the middle compartment, as further described below. Similarly, a second compartment 116, in accordance with an embodiment of the invention, may be a substantially rectangular box with opposing side walls 118, a back wall 120, a first open portion 126 situated opposite the back wall 120, an outside wall 124, and a second open portion 128 situated opposite the outside wall 124 and configured to receive a second flap of the middle compartment, as further described below. Although FIGS. 1 and 2 illustrate an embodiment of the invention being a container having storage compartments in a substantially rectangular shape suitable for a sandwich, the container and storage compartments described herein may be configured to house any food product, therefore, the container may also be implemented in any number of shapes including a circular shape, for example.

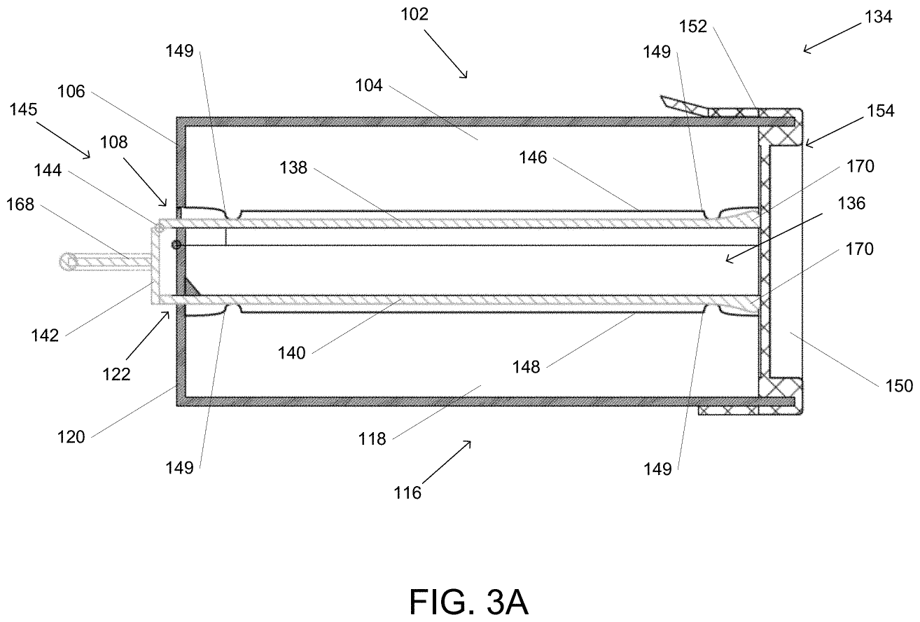

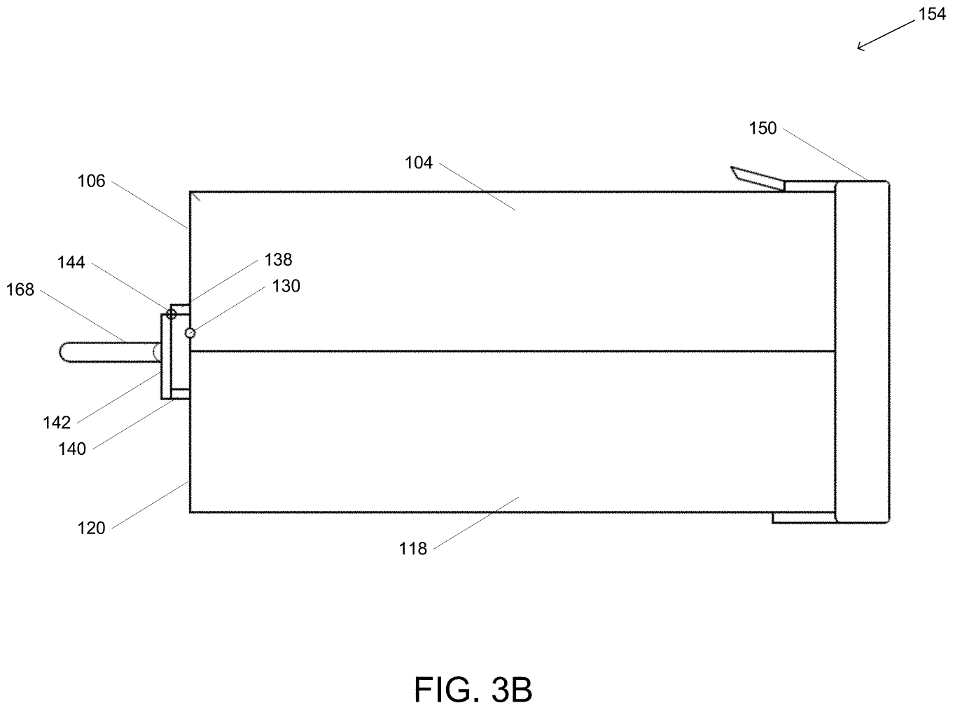

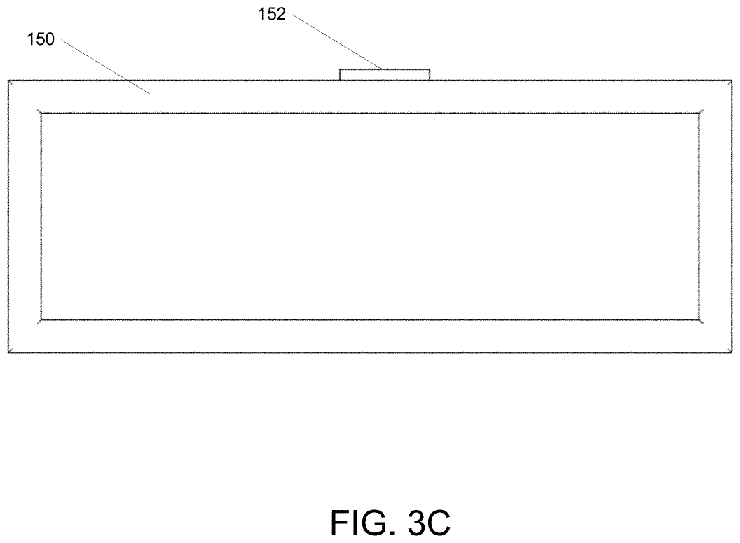

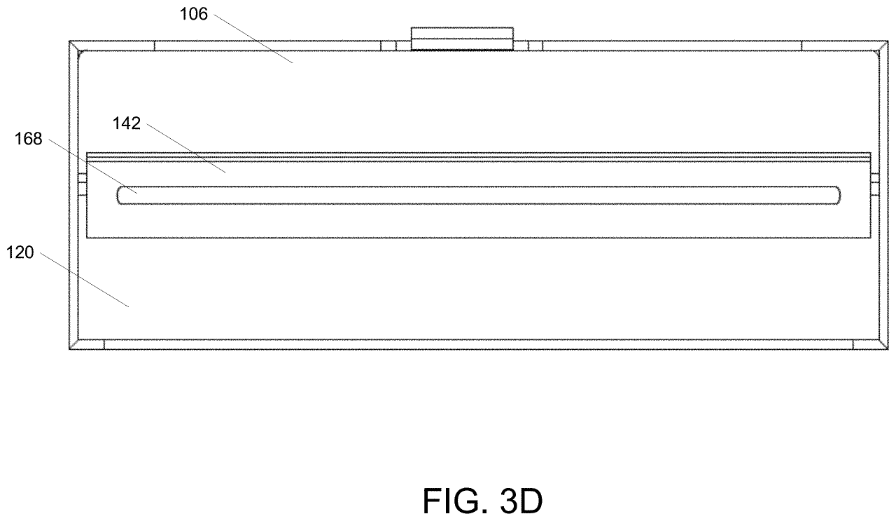

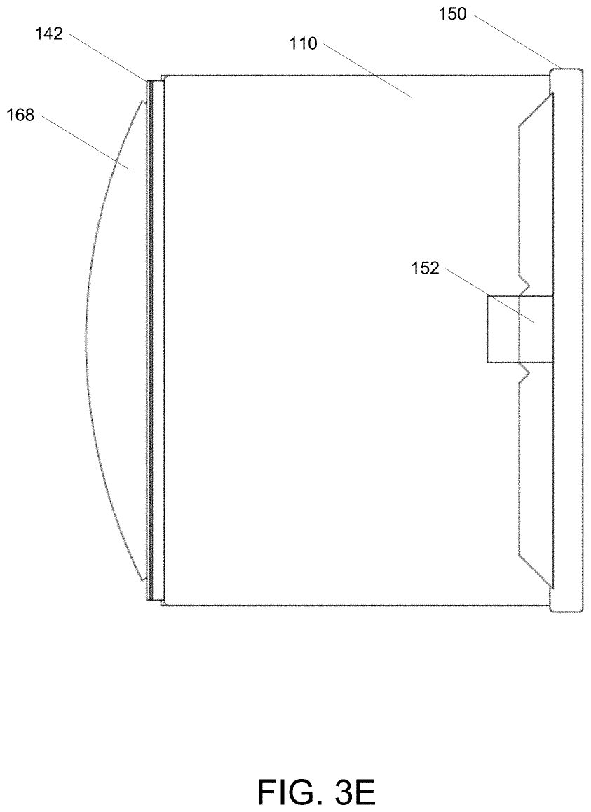

Turning to FIGS. 3A-3E, the container may also be placed in a closed configuration in accordance with several embodiments of the invention. In addition, the container may also include a lid 150 that may cover the first compartment 102, second compartment 116, and middle compartment 136 simultaneously for locking and unlocking the container. Therefore, a user may gain access to the three or more storage compartments of the container simply by removing the lid 150. A lid in a locked position 154 and the container in a closed configuration 134 is illustrated in FIGS. 3A-3B. As shown in FIG. 3C, the lid 150 may also include a closing fastener 152, which can be used to lock the lid 150 into the locked position 154 by securely fastening to one side of the container. The lid 150 may hingedly connect to one side of the container such that it can be rotated between an unlocked position 156 (FIG. 2) and a locked position 154 (FIGS. 3A-3B). In some embodiments of the invention, the lid 150 may be completely detachable from the container and may include grooves that correspond to grooves of the container such that the lid 150 may closely fit into a locked position 154.

As illustrated in FIGS. 3A-3B, in accordance with several embodiments of the present invention, the first compartment 102 may be connected to the second compartment 116, for example, along an edge of the back wall 106 of the first compartment 102 and an edge of the back wall 120 of the second compartment 106. In further embodiments, a first hinge 130 may be used to connect the first compartment 102 to the second compartment 116 such that the first compartment 102 or second compartment 116 can be rotated about the first hinge 130 to position the container between an open configuration 132 (FIG. 2), and a closed configuration 134 (FIG. 3A), as further described below.

For example, the open configuration 132 may involve rotating the first compartment 102 about the first hinge 130, which may connect the first compartment 102 to the second compartment 116, such that the opposing side walls 104 of the first compartment 102 and the opposing side walls 118 of the second compartment 116 are separated as illustrated in FIG. 2. In contrast, the closed configuration may involve rotating the first compartment 102 about the first hinge 130 such that the opposing side walls 104 of the first compartment 102 and the opposing side walls 118 of the second compartment 116 are brought into contact, as illustrated in FIG. 3.

In further reference to FIGS. 3A-3B. a middle compartment 136, in accordance with an embodiment of the invention, may include a first flap 138, a second flap 140, a connecting member 142, and a second hinge 144. The second hinge 144 may be used to connect the first flap 138 to the connecting member 142 such that the first flap 138 may rotate about the second hinge 144 when the container is positioned between the open configuration 132 (FIG. 2) and the closed configuration 134, and vice versa. The connecting member 142 may also connect to the second flap 140.

In further reference to FIG. 3A, first slotted tracks 146 may be disposed in the opposing side walls 104 of the first compartment 102 and second slotted tracks 148 may be disposed in the opposing side walls 118 of the second compartment 116, in accordance with an embodiment of the invention. As shown in FIG. 3A, the first flap 138 of the middle compartment 136 may move through a first opening 108 in the back wall 106 of the first compartment 102 and be guided by the first slotted tracks 146. Similarly, the second flap 140 may move through a second opening 122 in the back wall 120 of the second compartment 116 and be guided by the second slotted tracks 148. When inserted, the first flap 138 may create a barrier in the place of the second open portion 114 of the first compartment 102 (see FIG. 1), in accordance with an embodiment of the invention. Similarly, when inserted, the second flap 140 may create a barrier in the place of the second open portion 128 of the second compartment 116 (see FIG. 1). When the middle compartment 136 is inserted, three compartments may be formed with the first flap 138 and second flap 140 acting as barriers that separate the three compartments.

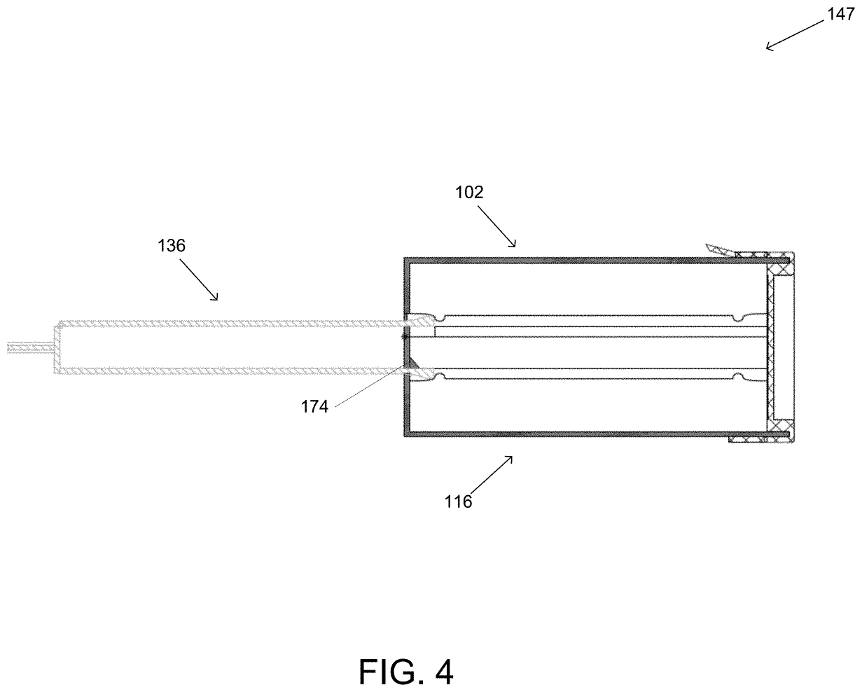

A rear view of a sandwich container in accordance with an embodiment of the invention is illustrated in FIG. 3D and a top view of a sandwich container with the middle compartment inserted in accordance with an embodiment of the invention is shown in FIG. 3E. In various embodiments, the connecting member 142 typically remains outside of the container and in some embodiments may include a tab 168 so that a user can grasp thereon and place the middle compartment 136 between an inserted position 145 (FIG. 3A) and a removed position 147 (FIG. 4), as further described below. While the middle compartment 136 is in an inserted position 145, sandwich fill ingredients may be placed in the middle compartment 136. For greater accessibility to the middle compartment 136, the container may be placed in the open configuration 132 while the middle compartment 136 is in the inserted position 145 as illustrated in FIG. 2.

In many embodiments of the invention, the first slotted tracks 146 and the second slotted tracks 148 may include latches 149 to lock the middle compartment 136 into the inserted position 145 or the removed position. The first flap 138 and second flap 140 may include end points 170 designed, as one of ordinary skill in the art would understand, to fit into the latches 149. While in the inserted position 145 (FIG. 3A), the middle compartment 136 may prevent cross-contamination between the multiple compartments. For example, sandwich fill ingredients placed in the middle compartment 136, a first piece of bread placed in the first compartment 102, and a second piece of bread placed in the second compartment 116 may be completely separated by the flaps 138, 140 of the middle compartment 136. This aspect of the present invention provides the advantage of separating wet food fill ingredients typically placed in a sandwich from the pieces of bread of the sandwich so that the bread does not become soggy during storage. Prevention of cross-contamination is further accomplished by a seal that may be created between the flaps of the middle compartment and the slotted tracks.

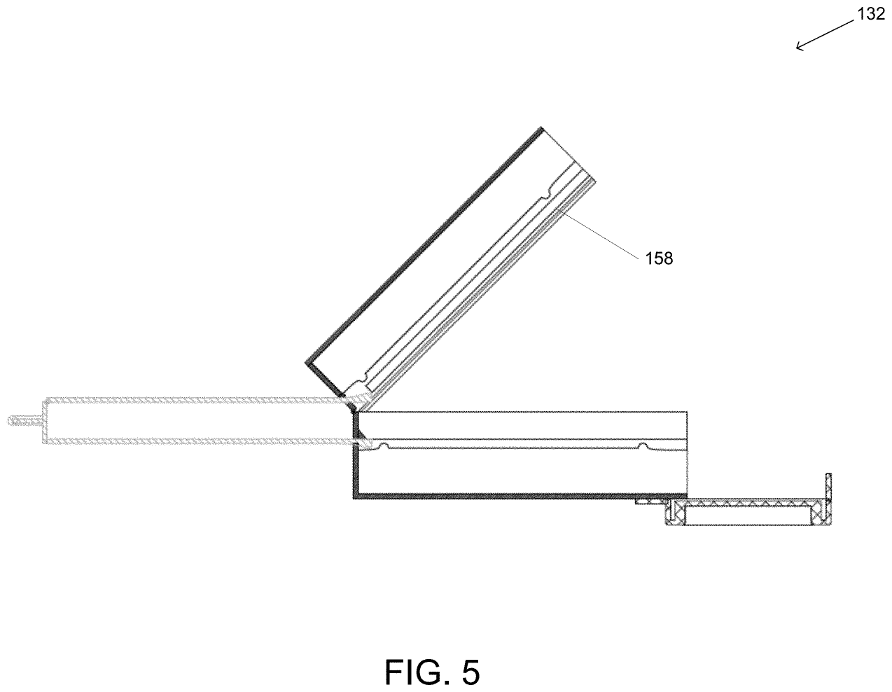

Turning to FIG. 4, the middle compartment 136 is shown in a removed position 147, in accordance with an embodiment of the invention. When the middle compartment 136 is positioned into the removed position 147, a first piece of bread placed in the first compartment 102, any fill ingredients placed in the middle compartment 136, and a second piece of bread placed in the second compartment 116 may be brought together, thereby assembling a sandwich. In various embodiments, the back walls of the first compartment 102 and second compartment 116 may act to block the food items of the container from escaping as the middle compartment 136 is removed. In some embodiments of the invention, the container may also include a grease trap 174 disposed in the first compartment 102 and/or second compartment 116 to prevent any leakage of, for example, grease, oil, or similar liquids, during storage or transitions of the middle compartment 136 between an inserted position 145 and removed position 147. For further accessibility to the assembled sandwich, the container may be positioned into the open configuration 132 while the middle compartment 136 is removed, as illustrated in FIG. 5.

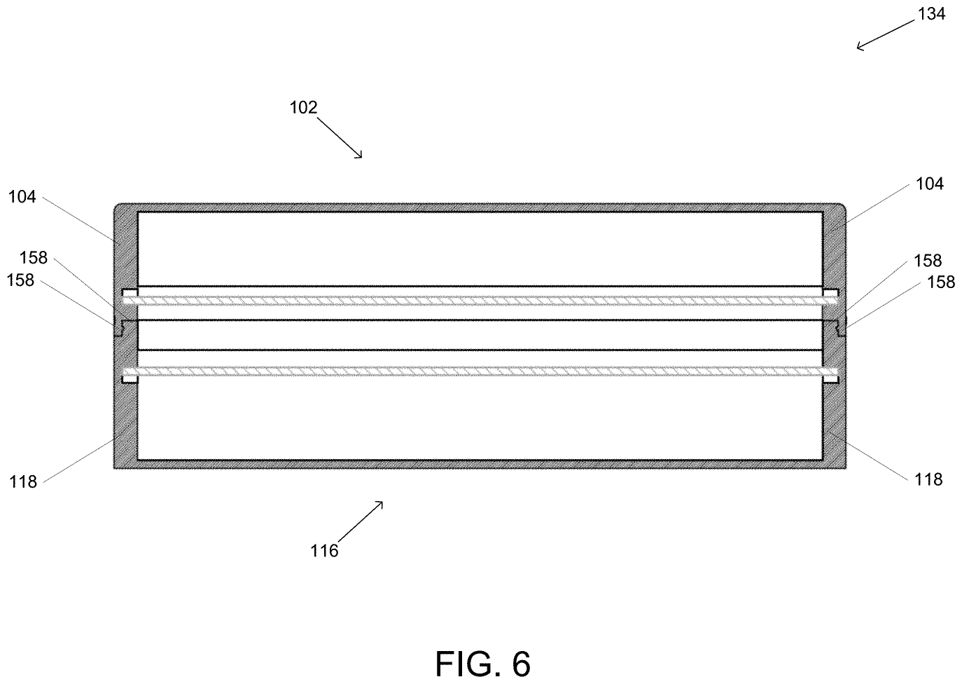

A left side cross-sectional view of a sandwich container with the middle compartment removed and the container in an open configuration in accordance with an embodiment of the invention is illustrated in FIG. 5. In addition, a rear cross-sectional view of a sandwich container with the container in a closed configuration in accordance with an embodiment of the invention is illustrated in FIG. 6. The opposing side walls 104 of the first compartment and the opposing side walls 118 of the second compartment may include grooves 158, in accordance with various embodiments of the invention. In reference to FIG. 6, the grooves 158 of the first compartment 102 may be configured to receive corresponding grooves 158 of the second compartment 116 when the container is positioned into the closed configuration 134. One of ordinary skill in the art would understand that the interlocking of the grooves 158 typically involve a strong joint, for example, a tongue and groove joint, to closely fit together the first compartment 102 and second compartment 116 such that the container does not leak its contents. In many embodiments of the invention, the interlocking of the grooves 158 will allow for the outside of the container to be have a single flat surface where the first compartment 102 and second compartment 116 meet.

Although exemplary embodiments of containers for storage and assembly of sandwiches are discussed above with respect to FIGS. 1-6, they should not be construed to limit other embodiments within the scope of the invention. Method for storing and assembling sandwiches, in accordance with embodiments of the invention are discussed further below.

### Methods for Storing and Assembling Sandwiches

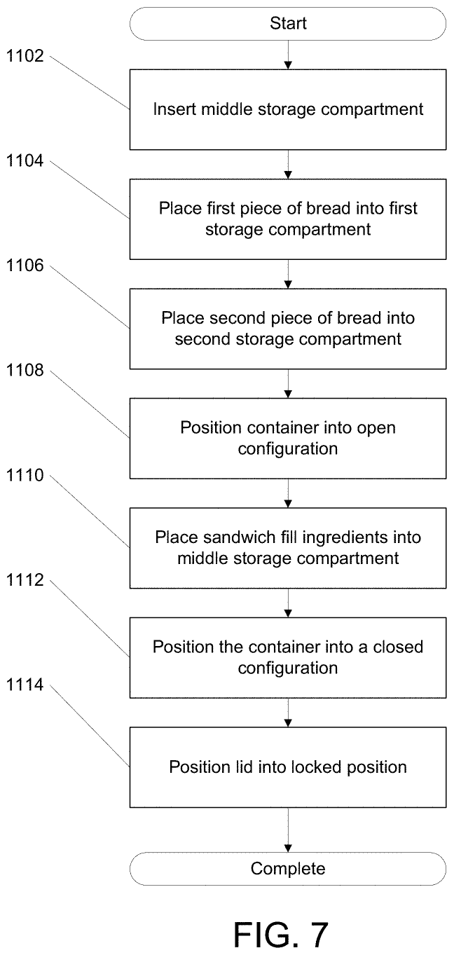

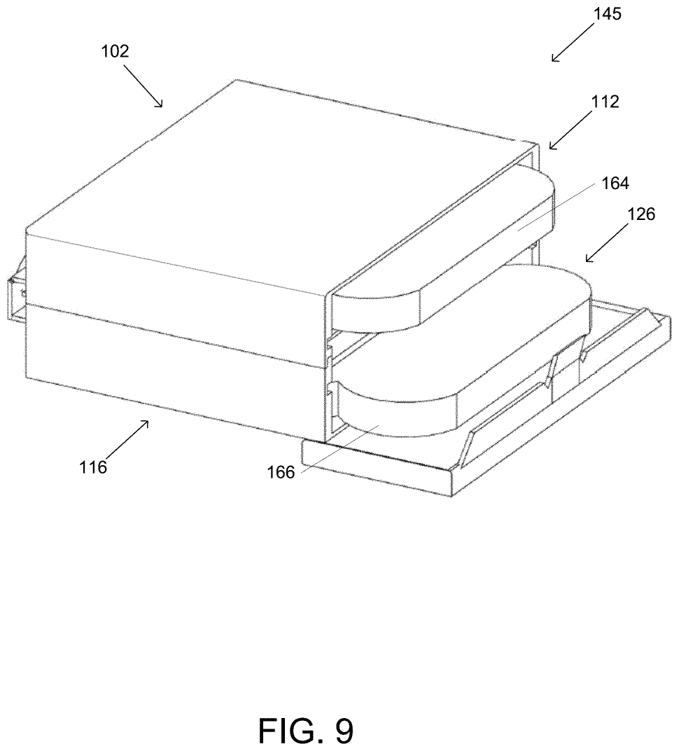

Another aspect of the invention provides a method for storing and assembling sandwiches. A flow chart illustrating a process for storing a sandwich in accordance with an embodiment of the invention is illustrated in FIG. 7. The method for storing a sandwich may include positioning (1102) a middle compartment of a container into an inserted position; placing (1104) a first piece of bread into a first compartment; placing (1106) a second piece of bread into a second compartment; positioning (1108) the container into an open configuration; placing (1110) sandwich fill ingredients into the middle compartment; positioning (1112) the container into a closed configuration; and/or positioning (1114) a lid into a locked position, as further described below in reference to FIGS. 9-11.

In accordance with various embodiments of the present invention, the positioning (1102) the middle compartment of a container into an inserted position step, as shown in FIG. 9, may be accomplished by grasping a tab located on the connecting member of the middle compartment and causing the first flap of the middle compartment to move between first slotted tracks disposed in the opposing side walls of the first compartment and the second flap of the middle compartment to move between second slotted tracks disposed in the opposing side walls of the second compartment such that the middle compartment is positioned into the inserted position 145. Latches disposed in the first slotted tracks and second slotted tracks may be used to lock the middle compartment into the inserted position 145 or removed position.

In further reference to FIG. 9, placing (1104) the first piece of bread 164 into the first compartment 102 and placing (1106) the second piece of bread 166 into the second compartment 116 in accordance with an embodiment of the invention is shown. The first piece of bread 164 may be placed into the first compartment 102 through the first open portion 112 of the first compartment 102. Similarly, the second piece of bread 166 may be placed into the second compartment 116 through the first open portion 126 of the second compartment 116.

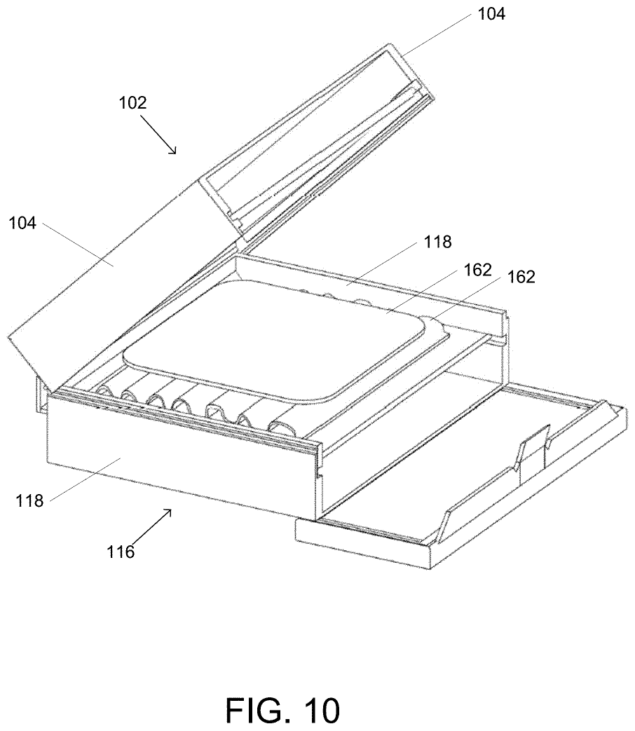

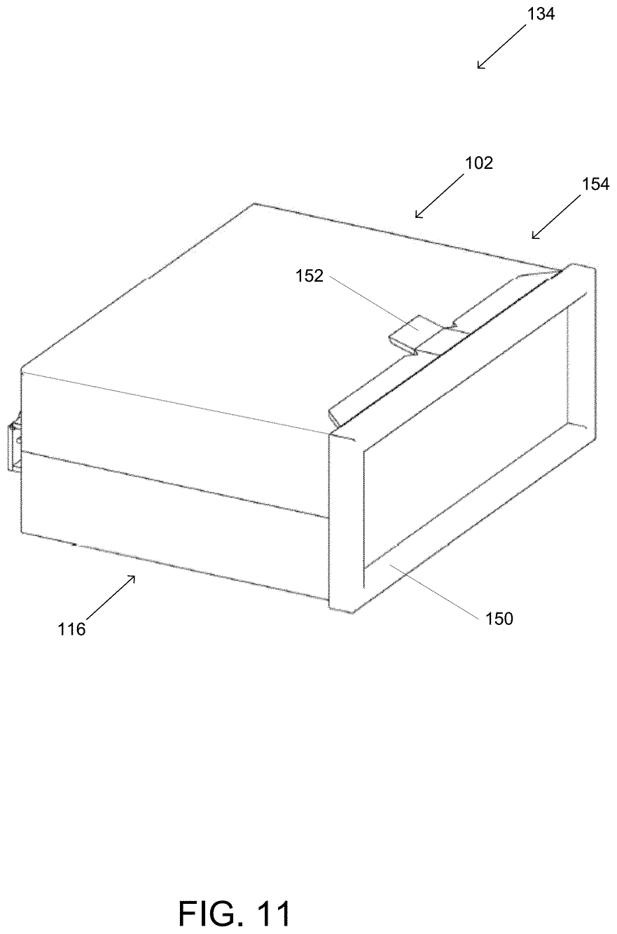

Positioning (1108) the container into an open configuration may involve rotating the first compartment 102 about a first hinge that connects the first compartment 102 to the second compartment 116 such that the opposing side walls 104 of the first compartment and the opposing side walls 118 of the second compartment are separated as shown in FIG. 10. In contrast, the positioning (1112) the container into a closed configuration may involve rotating the first compartment 102 about the first hinge such that the opposing side walls 104 of the first compartment and the opposing side walls 118 of the second compartment are brought into contact, as shown in FIG. 11. In some embodiments, the opposing side walls of the first compartment and second compartment include grooves that interlock when the container is in the closed configuration 134.

A front prospective view of a sandwich container showing the lid in an unlocked position and the container in an open configuration with fill ingredients inserted into the middle compartment in accordance with an embodiment of the invention is illustrated in FIG. 10. FIG. 10 further illustrates placing sandwich fill ingredients 162 into the middle compartment (1110) in accordance with an embodiment of the invention. A left side prospective view of a sandwich container showing the middle compartment inserted and the container in a closed configuration with the lid in a locked position in accordance with an embodiment of the invention is illustrated in FIG. 11. Positioning (1112) the container into a closed configuration and positioning (1114) a lid 150 into a locked position in accordance with an embodiment of the invention is shown in FIG. 11. When positioning the lid 150 into a locked position, a side of the lid covers the first open portion of the first compartment, the middle compartment, and the first open portion of the second compartment. In some embodiments, the lid 150 may include a closing fastener 152 that the user may attach to the first compartment 102 or second compartment 116 of the container to secure the contents of the container when the lid 150 is in the locked position 154.

In further embodiments of the invention, a user may be ready to assemble the sandwich, which may involve the process as illustrated in FIG. 7, as described above, and the further include positioning (1116) the lid into an unlocked position and positioning (1118) the middle compartment of the container into a removed position (1118). A left side prospective view of a sandwich container showing the middle compartment removed and the container in a closed configuration with the lid in a locked position in accordance with an embodiment of the invention. In many embodiments, the middle compartment of the container may be positioned into a removed position (1118), in accordance with an embodiment of the invention. Similar to inserting the middle compartment (1102), positioning (1118) the middle compartment into a removed position may be accomplished by grasping a tab 168 located on the connecting member of the middle compartment and causing the first flap 138 of the middle compartment 136 to move between first slotted tracks disposed in the opposing side walls 104 of the first compartment and the second flap 140 of the middle compartment 136 to move between second slotted tracks disposed in the opposing side walls 118 of the second compartment such that the middle compartment 136 is positioned into the removed position 147.

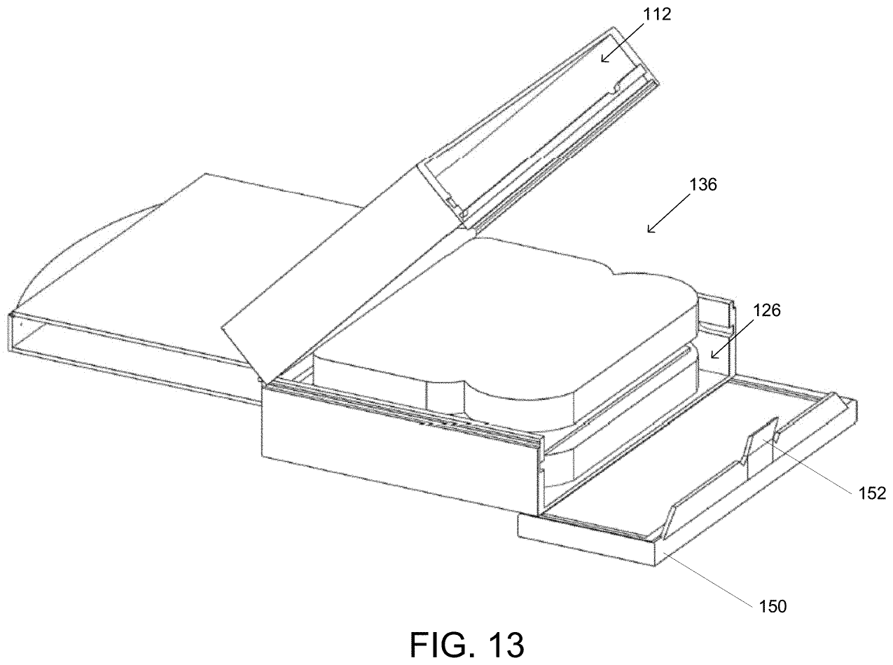

A left side prospective view of a sandwich container showing the middle compartment removed and the container in an open configuration with the lid in an unlocked position in accordance with an embodiment of the invention is illustrated in FIG. 13. In various embodiments the lid may be positioned (1116) into an unlocked position, in accordance with an embodiment of the invention, is shown in FIG. 13. In many embodiments of the invention, positioning (1116) the lid into an unlocked position may involve detaching the closing fastener 152 of the lid 150 from the container and positioning the lid 150 such that the side of the lid no longer covers the first open portion 112 of the first compartment, the middle compartment 136, and the first open portion 126 of the second compartment.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A container for storage and assembly of a sandwich, the container comprising:
a first compartment for receiving a first piece of bread, comprising opposing side walls, a back wall having a first opening, an outside wall, a first open portion opposite the back wall, and a second open portion opposite the outside wall;
a second compartment for receiving a second piece of bread, comprising opposing side walls, a back wall having a second opening, an outside wall, a first open portion opposite the back wall, and a second open portion being opposite the outside wall, wherein the first compartment back wall is connected to the second compartment back wall at a first hinge allowing for the container to be positioned between an open configuration and a closed configuration; and
a middle compartment comprising a first flap, a second flap connected to a connecting member, and a second hinge, wherein the connecting member connects with the first flap at the second hinge allowing for the first flap to rotate about the second hinge when the container is positioned between the open configuration and the closed configuration.

2. The container of claim 1, wherein the opposing side walls of the first storage container have first slotted tracks, and wherein the first flap is configured to be placed through the first opening and guided into the first slotted tracks of the opposing side walls of the first compartment.

3. The container of claim 2, wherein the opposing side walls of the second compartment have second slotted tracks, and wherein the second flap is configured to be placed through the second opening and guided into the second slotted tracks of the opposing side walls of the second compartment.

4. The container of claim 3, further comprising a lid having a closing fastener, wherein the lid hingedly connects to the second compartment allowing for the lid to be positioned between an unlocked position and a locked position, and wherein the closing fastener is configured to attach to the first compartment to secure the container when the lid is in the locked position.

5. The container of claim 3, wherein the first slotted tracks and the second slotted tracks have latches indicating an inserted middle compartment position and a removed middle compartment position, and wherein the first flap and the second flap have end points that lock into the latches and allow for the middle compartment to be positioned between the inserted position and removed position.

6. The container of claim 5, wherein the end points provide an audible sound when the middle compartment is positioned into the inserted position and the removed position.

7. The container of claim 1, wherein the back wall of the second compartment has a grease trap to prevent fill ingredients from escaping from the middle compartment.

8. The container of claim 1, wherein the connecting member has a tab to grasp.

9. The container of claim 1, further comprising:
a first set of grooves disposed in the opposing side walls of the first compartment; and
a second set of grooves disposed in the opposing side walls of the second compartment, wherein the first set of grooves and the second set of grooves are configured to interlock with each other when the container is placed into the closed configuration.

10. A method for storing and assembling a sandwich, the method comprising the steps of:
positioning a middle compartment of a container into an inserted position, the middle compartment comprising: a first flap, a second flap connected to a connecting member, and a second hinge, wherein the connecting member connects with the first flap at the second hinge allowing for the first flap to rotate about the second hinge when the container is positioned between an open configuration and a closed configuration;
placing a first piece of bread into a first compartment, the first compartment comprising: opposing side walls, a back wall having a first opening, an outside wall, a first open portion opposite the back wall, and a second open portion opposite the outside wall;
placing a second piece of bread into a second compartment, the second compartment comprising: opposing side walls, a back wall having a second opening, an outside wall, a first open portion opposite the back wall, and a second open portion being opposite the outside wall;
positioning the container into an open configuration;
placing sandwich fill ingredients into the middle compartment; and
positioning the container into a closed configuration.

11. The method of claim 10, wherein the positioning the middle compartment into the inserted position step comprises the step of: grasping a tab located on the connecting member of the middle compartment and causing the first flap to move between first slotted tracks disposed in the opposing side walls of the first compartment and the second flap to move between second slotted tracks disposed in the opposing side walls of the second compartment such that the middle compartment is positioned into the inserted position.

12. The method of claim 11, wherein the placing the first piece of bread in the first compartment comprises the step of: placing the first piece of bread through the first open portion of the first compartment and into the first compartment.

13. The method of claim 12, wherein the placing the second piece of bread in the second compartment comprises the step of: placing the second piece of bread through the first open portion of the second compartment and into the second compartment.

14. The method of claim 13, wherein the positioning the container into an open configuration step comprises the step of: rotating the first compartment about a first hinge such that the container is positioned into the open configuration, wherein the first hinge connects the first compartment to the second compartment.

15. The method of claim 14, wherein the positioning the container into a closed configuration step comprises the step of: rotating the first compartment about the first hinge such that the container is positioned into the closed configuration.

16. The method of claim 10, further comprising: positioning a lid into a locked position, the lid having a closing fastener and the lid being connected to the container.

17. The method of claim 16, wherein the positioning the lid into the locked position comprises the steps of:
positioning the lid such that a side of the lid covers the first open portion of the first compartment, the middle compartment, and the first open portion of the second compartment; and
attaching the closing fastener to the first compartment to secure the container when the lid is in the locked position.

18. The method of claim 17, further comprising the steps of:
positioning the lid into an unlocked position; and
positioning the middle compartment of the container into a removed position.

19. The method of claim of 18, wherein the positioning the lid into the unlocked position comprises the steps of:
detaching the closing fastener from the first compartment; and
positioning the lid such that the side of the lid no longer covers the first open portion of the first compartment, the middle compartment, and the first open portion of the second compartment.

20. The method of claim 19, wherein the positioning the middle compartment into the removed position step comprises the step of: grasping the tab located on the connecting member of the middle compartment and causing the first flap to move between first slotted tracks disposed in the opposing side walls of the first compartment and the second flap to move between second slotted tracks disposed in the opposing side walls of the second compartment such that the middle compartment is positioned into the removed position.
